(19) United States
(12) Patent Application Publication
(10) Pub. No.: US 2026/0088722 A1
(43) Pub. Date: Mar. 26, 2026

(54) CONTROL CIRCUIT AND DC-DC CONVERTER

(71) Applicant: ROHM CO., LTD., Kyoto (JP)

(72) Inventors: Misaki KOZAKA, Kyoto (JP); Tadashi AKAHO, Kyoto (JP); Kazuma FUKATANI, Kyoto (JP); Yasuto YOSHIOKA, Kyoto (JP)

(21) Appl. No.: 19/398,550

(22) Filed: Nov. 24, 2025

Related U.S. Application Data
(63) Continuation of application No. PCT/JP2024/019511, filed on May 28, 2024.

(30) Foreign Application Priority Data
May 31, 2023 (JP) 2023-089905

(51) Int. Cl. H02M 3/158

(52) U.S. Cl. CPC H02M 3/1586

(57) ABSTRACT

A control circuit (200, 200a) controls a multiphase DC-DC converter (100, 100a) including switching output stages for a plurality of channels (Ch1 to Ch4). It has a multiphase controller (204) that determines the number of enabled channels according to a load current (Iout). When increasing the number of enabled channels, the multiphase controller (204) first switches to the maximum number of channels.

### CROSS-REFERENCE TO RELATED APPLICATIONS

This nonprovisional application is a continuation application of International Patent Application No. PCT/JP2024/019511 filed on May 28, 2024, which claims priority to Japanese Patent Application No. 2023-089905 filed on May 31, 2023, the entire contents of which are hereby incorporated by reference.

### TECHNICAL FIELD

The present disclosure relates to control circuits, and to DC-DC converters controlled by a control circuit.

### Background Art

Some known DC-DC converters include switching output stages for a plurality of channels and supplies electric power to a load while switching enabled channels (see, for example, Patent Document 1). In such DC-DC converters, a control circuit switches the number of enabled channels based on the load current that is supplied to the load.

### CITATION LIST

### Patent Literature

Patent Document 1: Japanese Unexamined Patent Application No. 2017-135812

### SUMMARY OF INVENTION

### Technical Problem

In a DC-DC converter, if the output of the load varies or the load is replaced, the load current may vary. A sharp rise in the load current makes the electric charge extracted from an output capacitor higher than the electric charge with which the output capacitor is charged, resulting in a drop in the output voltage. A drop in the output voltage may destabilize the operation of the load.

### Solution to Problem

According to the present disclosure, for example, a control circuit is configured to control a multiphase DC-DC converter including switching output stages for a plurality of channels. The control circuit includes a multiphase controller that determines the number of enabled channels according to a load current. When increasing the number of enabled channels, the multiphase controller first switches to the maximum number of channels.

### Advantageous Effects of Invention

According to the present disclosure, in a multiphase DC-DC converter, it is possible to suppress variation of the output voltage resulting from variation of the load current.

### BRIEF DESCRIPTION OF DRAWINGS

FIG. 1 is an overall configuration diagram of a DC-DC converter according to one embodiment of the present disclosure.

FIG. 2 is a schematic circuit diagram of a pulse signal generator.

FIG. 3 is a timing chart obtained as the number of phases changes in the DC-DC converter.

FIG. 4 is a flow chart showing a procedure for changing the number of phases in the DC-DC converter.

FIG. 5 is an overall configuration diagram of a DC-DC converter according to a modified example of the present disclosure.

FIG. 6 is a schematic circuit diagram of a pulse signal generator of each channel.

FIG. 7 is a timing chart showing the operation of the pulse signal generator.

FIG. 8 is a timing chart obtained as the number of phases changes in the DC-DC converter according to the modified example.

### DESCRIPTION OF EMBODIMENTS

Examples of implementing the present disclosure will be described specifically below with reference to the accompanying drawings. In the diagrams referred to in the course, the same parts are identified by the same reference signs and, for the same parts, in principle no overlapping description will be repeated.

First, some of the terms used in the description of embodiments of the present disclosure will be defined. “Line” denotes a wiring across which an electrical signal is transmitted or to which one is applied. “Ground” denotes a reference conductive member at a reference potential of 0 V (zero volts) or a potential of 0 V itself. A reference conductive member is formed of an electrically conductive material such as metal. A 0 V potential is referred to also as a ground potential. In embodiments of the present disclosure, any voltage mentioned with no reference mentioned is a potential relative to the ground.

In the present description, a MOS (metal-oxide-semiconductor) field-effect transistor denotes a transistor of which the gate has a structure composed of at least three layers of a layer of a conductor or of a semiconductor with a low resistance value such as polysilicon, a layer of an insulator, and a layer of P-channel, N-channel, or intrinsic semiconductor. That is, a MOS field-effect transistor can have any gate structure other than one composed of three layers of a metal, an oxide, and a semiconductor.

“Level” denotes the level of a potential and, for a given signal or voltage, high level denotes a potential higher than low level. Any digital signal takes as its signal level either high level or low level. For a given signal or voltage of interest, its being at high level denotes, more precisely, its signal or voltage level being high level, and its being at low level denotes, more precisely, its signal or voltage level being low level. A level of a signal can be referred to as a signal level, and a level of a voltage can be referred to as a voltage level. For a given signal of interest, if it is at high level, its inversion signal is at low level and, if it is at low level, its inversion signal is at high level.

For any signal that takes as its signal level either high level or low level, a period in which it is at high level is referred to as a high-level period. Likewise, for any such signal, a period in which it is at low level is referred to as a low-level period. The same applies to any voltage that takes as its voltage level either high level or low level.

If a switching transistor is in on state, it conducts across its terminals. On the other hand, if a switching transistor is in off state, it does not conduct across its terminals. In the following description, for a switching transistor, its being in on or off state is occasionally referred to simply as its being on or off. A period in which a switching transistor is in on state is often referred to an on period, and a period in which a switching transistor is in off state is often referred to an off period. A switch of a switching transistor from off state to on state is often referred to as a turn-on, and a switch of a switching transistor from on state to off state is often referred to as its turn-off.

For any transistor configured as a field-effect transistor, which can be a MOS field-effect transistor, on state denotes a state in which the transistor conducts between its drain and source, and off state denotes a state in which the transistor does not conduct between its drain and source (cut-off state). The same applies to any transistor that is not classified as a field-effect transistor. For any MOS field-effect transistor mentioned in the following description, unless otherwise stated, its back gate is connected to its source.

Among a plurality of parts constituting a circuit, as among circuit elements, wires (lines), and nodes, “connection” denotes not only mechanical connection but also electrical connection, that is, their being combined together such that electric currents can pass among them. That is, “connecting”them can involve “electrically connecting”them.

### DC-DC Converter 100

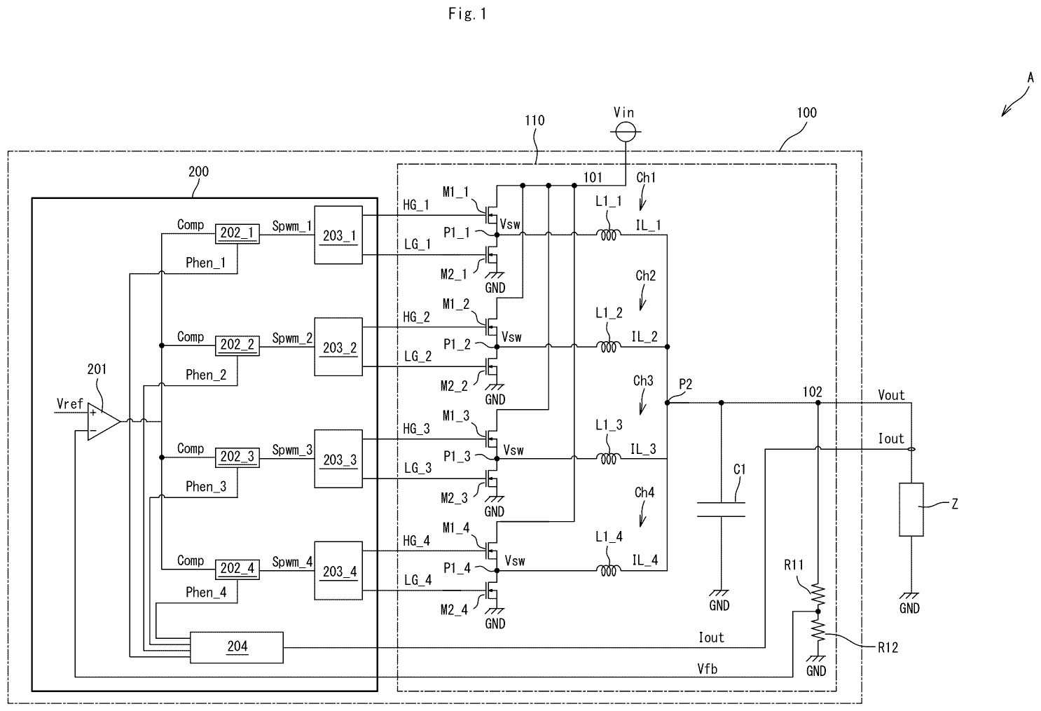

FIG. 1 is an overall configuration diagram of a DC-DC converter 100 according to one embodiment of the present disclosure. The DC-DC converter 100 shown in FIG. 1 has a line 101 that is supplied with a direct-current input voltage Vin, and has an output line 102 that is connected to a load Z.

The DC-DC converter 100 receives the input voltage Vin on the input line 101 and produces a bucked (stepped-down) output voltage Vout on the output line 102. The DC-DC converter 100 is composed of M-channel switching output stages (where M is an integer of two or more). It can have any number M of channels, e.g., two channels, three channels, four channels, six channels, eight channels, 12 channels, or 16 channels, and the number M of channels is determined to suit the load. In the following description, the DC-DC converter 100 of the embodiment is assumed to have four channels. The DC-DC converter 100 has an output circuit 110 and a control circuit 200.

### Output Circuit 110

The output circuit 110 has, for each of channels Ch1 to Ch4, a half-bridge inverter constituted by a high-side switching transistor M1, a low-side switching transistor M2, and an inductor L1. The output circuit 110 also has, to be shared among channels Ch1 to Ch4, an output capacitor C1 and resistors R11 and R12. The resistors R11 and R12 divides the output voltage Vout to produce a feedback signal Vfb corresponding to the output voltage Vout. The feedback signal Vfb is fed back to the control circuit 200.

In the present description, a channel number is appended as a suffix wherever necessary. For example, for channel Ch2, the relevant elements are referred to as the high-side switching transistor M1_2, the low-side switching transistor M2_2, and the inductor L1_2.

Here, in the switching output stage of each channel, the high-side switching transistor M1 is an n-channel MOS transistor and the low-side switching transistor M2 is an n-channel MOS transistor. The drain of the high-side switching transistor M1 is connected to the input line 101. That is, the drain of the high-side switching transistor M1 is fed with the input voltage Vin.

In the switching output stage of each channel, the source of the high-side switching transistor M1 and the drain of the low-side switching transistor M2 are connected together at a connection point P1.

The source of the low-side switching transistor M2 is connected to a ground potential GND. At the connection point P1, a switching voltage Vsw appears. In any enabled channels Ch1 to Ch4, the switching voltage Vsw is substantially the same.

The gate of the high-side switching transistor M1 is connected to a driver 203, which will be described later, to be fed with a high-side driving signal HG, which will be described later. On the other hand, the gate of the low-side switching transistor M2 is connected to the driver 203 to be fed with a low-side driving signal LG, which will be described later. As will be described in detail later, when the high-side driving signal HG is at high level the high-side switching transistor M1 is in on state; when the low-side driving signal LG is at high level, the low-side switching transistor M2 is in on state.

In each channel, the first terminal of the inductor L1 is connected to the connection point P1. In each channel, the second terminal of the inductor L1 is connected to a connection point P2, which is shared among all the channels. The first terminal of the output capacitor C1 is connected to the connection point P2, and the connection point P2 is connected to the ground potential. The connection point P2 and the first terminal of the output capacitor C1 are connected to the output line 102, and the output line 102 is connected to the load Z.

### Control Circuit 200

The control circuit 200 is a functional IC (integrated circuit) integrated on a single semiconductor substrate. Based on a load current Iout, the control circuit 200 controls the high-side and low-side switching transistors M1 and M2 in any enabled channel Ch1 to Ch4. The high-side and low-side switching transistors M1 and M2 can be integrated in the control circuit 200.

As shown in FIG. 1, the control circuit 200 has, to be shared among different channels, an error amplifier 201 and, for respective channels, pulse signal generators 202_1 to 202_4 and drivers 203_1 to 203_4, along with a multiphase controller 204.

The error amplifier 201 amplifies the difference between the feedback signal Vfb, which corresponds to the output voltage Vout of the DC-DC converter 100, and its target value Vref to generate a difference signal Comp. The inverting input terminal of the error amplifier 201 is fed with the feedback signal Vfb, and its non-inverting input terminal is fed with the target value Vref.

### Pulse Signal Generator 202

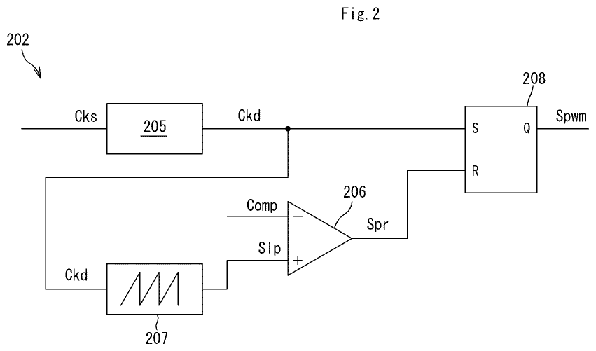

FIG. 2 is a schematic circuit diagram of the pulse signal generator 202. In the pulse signal generator 202 shown in FIG. 2, the suffixes are omitted. The pulse signal generator 202 can handle multiple channels; specifically, it is provided one for each channel. As shown in FIG. 2, each pulse signal generator 202 has a clock signal generator 205, a PWM comparator 206, a slope circuit 207, and an RS latch circuit 208.

The clock signal generator 205 is fed with a system clock signal Cks, which serves as a reference for the operation of the control circuit 200. Based on the system clock signal Cks, the clock signal generator 205 generates a pulse clock signal Ckd. The pulse clock signal Ckd is a pulse signal that specifies the rise timing of a PWM (pulse-width modulation) signal Spwm, which will be described later. The pulse clock signal Ckd is a pulse signal that rises in response to a rise or a fall of the system clock signal Cks, and the rise timing of the pulse clock signal Ckd is determined for each channel.

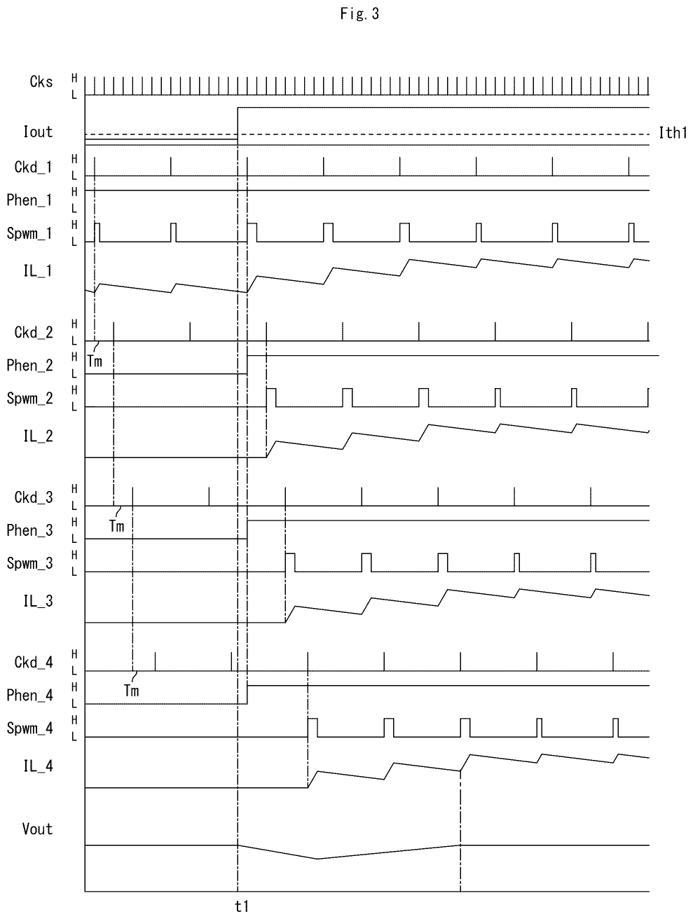

The clock signal generator 205 of each channel generates a pulse clock signal Ckd with a phase shifted relative to the pulse clock signals Ckd of the other channels (see FIG. 3 referred to later). Shifting the pulse clock signal Ckd from one channel to another in this way results in shifting from one channel to another the turn-on and turn-off timings of the high-side switching transistor M1 and the turn-on and turn-off timings of the low-side switching transistor M2. This helps reduce the switching noise generated.

The slope circuit 207 generates a slope signal Slp which is, for example, a voltage signal with a sawtooth waveform. The slope circuit 207 is fed with the pulse clock signal Ckd. The slope circuit 207 generates the slope signal Slp in synchronization with the rise timing of the pulse clock signal Ckd.

The PWM comparator 206 compares the difference signal Comp with the slope signal Slp. The non-inverting input terminal of the PWM comparator 206 is fed with the difference signal Comp and its inverting input terminal is fed with the slope signal Slp. The PWM comparator 206 outputs a PWM reset signal Spr that indicates the result of comparison of the difference signal Comp with the slope signal Slp. The PWM reset signal Spr is at high level if the difference signal Comp is lower than the slope signal Slp and is otherwise at low level.

The set terminal of the RS latch circuit 208 is fed with the pulse clock signal Ckd. The reset terminal of the RS latch circuit 208 is fed with the PWM reset signal Spr. The output of the RS latch circuit 208 is the PWM signal Spwm. As will be described in detail later, the PWM signal Spwm rises to high level at the rise timing of the pulse clock signal Ckd to high level. At that time, the slope signal Slp is lower than the difference signal Comp, and thus the PWM reset signal Spr is at low level. Accordingly, the PWM signal Spwm, which is the output of the RS latch circuit 208, is held at high level.

When the slope signal Slp becomes higher than the difference signal Comp, the PWM reset signal Spr turns to high level. As a result, the PWM signal Spwm output from the RS latch circuit 208 turns to low level. That is, the PWM signal Spwm rises at the rise timing of the pulse clock signal Ckd, and stays at high level for a period in which it is higher than the difference signal Comp.

The PWM signal Spwm generated in the pulse signal generator 202 of each channel is fed to the driver 203 of that channel.

Based on the PWM signal Spwm, the driver 203 of each channel generates the high-side and low-side driving signals HG and LG so as to turn on and off the high-side and low-side switching transistors M1 and M2 complementarily.

Note that “complementarily” here means that the high-side and low-side switching transistors M1 and M2 are turned on and off in opposite ways. The PWM signal Spwm is a signal that indicates the period in which the high-side switching transistor M1 is on.

The high level of the high-side driving signal HG is a voltage level that turns on the high-side switching transistor M1. Likewise, the high level of the low-side driving signal LG is a voltage level that is needed to turn on the low-side switching transistor M2.

The high-side and low-side driving signals HG and LG output from the driver 203 of each channel do not need to be turned on and off in completely opposite ways. Instead, for example, a dead time can be provided in which the high-side and low-side switching transistors M1 and M2 are both off.

The multiphase controller 204 acquires the load current Iout. Based on the load current Iout, the multiphase controller 204 determines the number of channels (number of phases) to enable.

The multiphase controller 204 feeds an enable signal Phen to the pulse signal generator 202 of each channel. The enable signal Phen is a signal that takes either low level or high level. Any channel to which a high-level enable signal Phen is fed is an enabled channel.

The multiphase controller 204 compares the load current Iout with each of threshold values Ith1, Ith2, and Ith3 and based on the result determines the number of channels (number of phases) to enable. The multiphase controller 204 determines the number of enabled channels to be one if the load current Iout is less than the threshold value Ith1, two if the load current Iout is more than or equal to the threshold value Ith1 but less than the threshold value Ith2, three if the load current Iout is more than or equal to the threshold value Ith2 but less than the threshold value Ith3, and four if the load current Iout is more than or equal to the threshold value Ith1.

In the embodiment, if the multiphase controller 204 determines the number of enabled channels to be one, channel Ch1 is enabled. Likewise, if the multiphase controller 204 determines the number of enabled channels to be two, channels Ch1 and Ch2 are enabled; if it determines the number of enabled channels to be three, channels Ch1 to Ch3 are enabled; and if it determines the number of enabled channels to be four, channels Ch1 to Ch4 are enabled.

The control circuit 200, and the DC-DC converter 100 that incorporates it, are configured as described above.

### Operation of the DC-DC Converter 100

The DC-DC converter 100 operates so as to suppress a drop in the output voltage Vout in response to a sharp rise in the load current Iout. Specifically, if the load current Iout exceeds the range determined by the current threshold values, regardless of the value that the load current Iout eventually takes, the multiphase controller 204 performs phase change operation to switch phases.

In the DC-DC converter 100, so long as it operates with a number of enabled channels greater than the number of enabled channels determined based on the load current Iout and the threshold values Ith1, Ith2, and Ith3, the switching output stages of channels Ch1 to Ch4 can operate well within their capacity. Thus, no problems are likely to result.

On the other hand, when the DC-DC converter 100 operates with a number of enabled channels less than the determined number of enabled channels, electric charge is extracted from the output capacitor C1 and the output voltage Vout drops. Accordingly, if as a result of comparison of the load current Iout with the threshold values Ith1, Ith2, and Ith3 the multiphase controller 204 judges it necessary to increase the number of enabled channels, it enables all the channels. Now, the operation observed as the number of channels changes in the DC-DC converter 100 will be described with reference to the relevant diagrams.

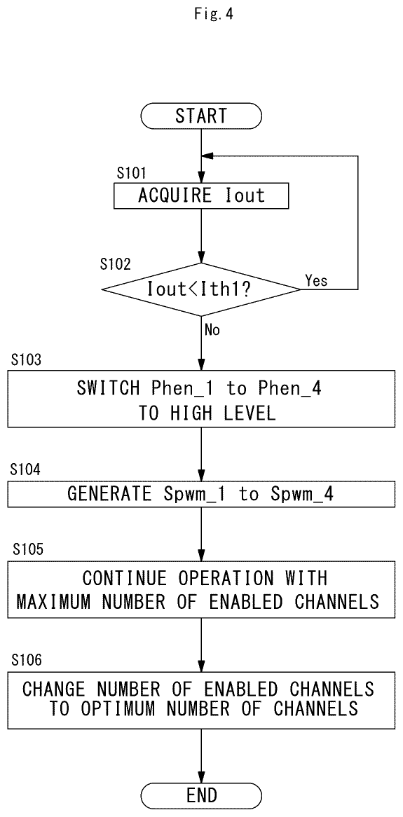

FIG. 3 is a timing chart obtained as the number of phases changes in the DC-DC converter 100. FIG. 4 is a flow chart showing a procedure for changing the number of phases in the DC-DC converter 100. For ease of understanding, what is presented in any timing chart in the present description is enlarged or reduced along the vertical and horizontal axes wherever appropriate. Also, for ease of understanding, any waveform presented is simplified, exaggerated, or emphasized wherever appropriate.

The timing chart in FIG. 3 depicts the change with time of: the system clock signal Cks; the load current Iout; the enable signals Phen_1 to Phen_4, the pulse clock signals Ckd_1 to Ckd_4, the PWM signals Spwm_1 to Spwm_4, and the inductor currents IL_1 to IL_4 of the individual channels; and the output voltage Vout.

In the timing chart in FIG. 3, before time t1, the number of enabled channels is one; at time t1, the load current Iout increases and the number of phases increases. As shown in FIG. 3, before time t1, the load current Iout is less than the threshold value Ith1. Accordingly, the multiphase controller 204 outputs the enable signal Phen_1 of channel Ch1 at high level and the enable signals Phen_2 to Phen_4 of the other channels Ch2 to 4 at low level.

Note that, during the period before time t1, the load current Iout and the output voltage Vout are stable. Accordingly, during that period, the PWM signal Spwm_1 has an on-duty ratio enough to keep a constant inductor current IL_1 and a constant switching voltage Vsw.

As shown in FIG. 3, the pulse clock signal Ckd_2 of channel Ch2 is delayed by a time Tm relative to the pulse clock signal Ckd_1 of channel Ch1. Likewise, the pulse clock signal Ckd_3 is delayed by a time Tm relative to the pulse clock signal Ckd_2, and the pulse clock signal Ckd_4 is delayed by a time Tm relative to the pulse clock signal Ckd_3. The pulse clock signals Ckd_1 to Ckd_4 rising with shifted timings in this way helps suppress the switching noise resulting from the individual switching output stages operating simultaneously.

Before time t1, the enable signal Phen_1 alone is at high level. Accordingly, the pulse signal generator 202_1 of channel Ch1 alone generates the PWM signal Spwm_1 such that it rises to high level. The PWM signals Spwm_2 to Spwm_4 output from the pulse signal generators 202_2 to 202_4 of the other channels Ch2 to Ch4 are fixed at low level.

As shown in FIG. 4, the multiphase controller 204 acquires the load current Iout (Step S101). The multiphase controller 204 checks whether the current load current Iout is less than the threshold value Ith1 (Step S102). If the load current Iout is judged to be less than the threshold value Ith1 (Step S102, Yes), the multiphase controller 204 decides to keep the current number of channels and returns to the acquiring of the load current Iout (Step S101). Note that it is because this embodiment employs a configuration where the number of enabled channels is increased from one that the load current Iout is compared with the threshold value Ith1; which threshold value to use varies according to the current number of channels.

If the load current Iout is judged to be more than or equal to the threshold value Ith1 (Step S102, No), the multiphase controller 204 judges it necessary to increase the number of enabled channels. The multiphase controller 204 then switches the enable signals Phen_2 to Phen_4 to high level (Step S103).

As shown in FIG. 3, after time t1, at the timing of comparison of the load current Iout with the threshold value Ith1, the enable signals Phen_2 to Phen_4 switch to high level to enable all the channels. Immediately after the enable signals Phen_2 to Phen_4 switch to high level, at the rise timings of the pulse clock signals Ckd_2 to Ckd_4, the pulse signal generators 202_2 to 202_4 generate the PWM signals Spwm_2 to Spwm_4 such that they rise (Step S204). That is, in the DC-DC converter 100, when increasing the number of enabled channels, the control circuit 200 first decides to sets it to the maximum number of channels.

There can be a case where, even with the DC-DC converter 100 operating with the maximum number of channels, the output voltage Vout does not immediately settle at the determined voltage. To cope with that, for a previously determined period, with all the channels enabled, the DC-DC converter 100 is kept operating (Step S105). The previously determined period is a period required for the output voltage Vout to stabilize at a constant voltage. Accordingly, instead of switching based on a period, it is possible to monitor the output voltage Vout and keep the DC-DC converter 100 operating with all the channels enabled until the output voltage Vout stabilizes at a constant voltage.

In the DC-DC converter 100, when it is operated with a number of enabled channels greater than the optimum number of enabled channels, the switching output stages of the individual channels can operate stably well within their capacity. This, however, means increased power consumption. To cope with that, at the lapse of a predetermined period, in the DC-DC converter 100, the multiphase controller 204 changes the number of enabled channels to a number of enabled channels that suits the load current Iout (Step S106). In the DC-DC converter 100, the multiphase controller 204 determines the optimum number of enabled channels based on the load current Iout.

Moreover, in the DC-DC converter 100, also when the number of enabled channels is reduced, the output voltage Vout may vary. To cope with that, in the DC-DC converter 100, when the number of enabled channels is reduced, the control circuit 200 reduces it one channel at a time. By reducing it in that way, it is possible, while suppressing variation of the output voltage Vout, suppress the electric power consumed by the DC-DC converter 100.

While the embodiment deals with a case where, starting in a state where the number of enabled channels is one, the number of enabled channels is increased as the load current Iout increases, this is not meant as any limitation. Instead, for example, also when increasing the number of enabled channels starting in a state where the number of enabled channels is two, the multiphase controller 204 controls by first setting it to the maximum number of channels and then changing it to the optimum number of enabled channels.

As described above, in the DC-DC converter 100, when increasing the number of enabled channels, the multiphase controller 204 first sets it to the maximum number of channels and then adjusts it to the optimum number of enabled channels. On the other hand, when reducing the number of enabled channels, the multiphase controller 204 reduces it one channel at a time. With the DC-DC converter 100 changing the number of enabled channels in the manners described above, even if the load current Iout varies, it is possible to suppress the fall (variation) of the output voltage Vout. In this way, the DC-DC converter 100 can supply the load Z with a stable voltage and a stable current and thereby stabilize the operation of the load Z.

### Modified Example

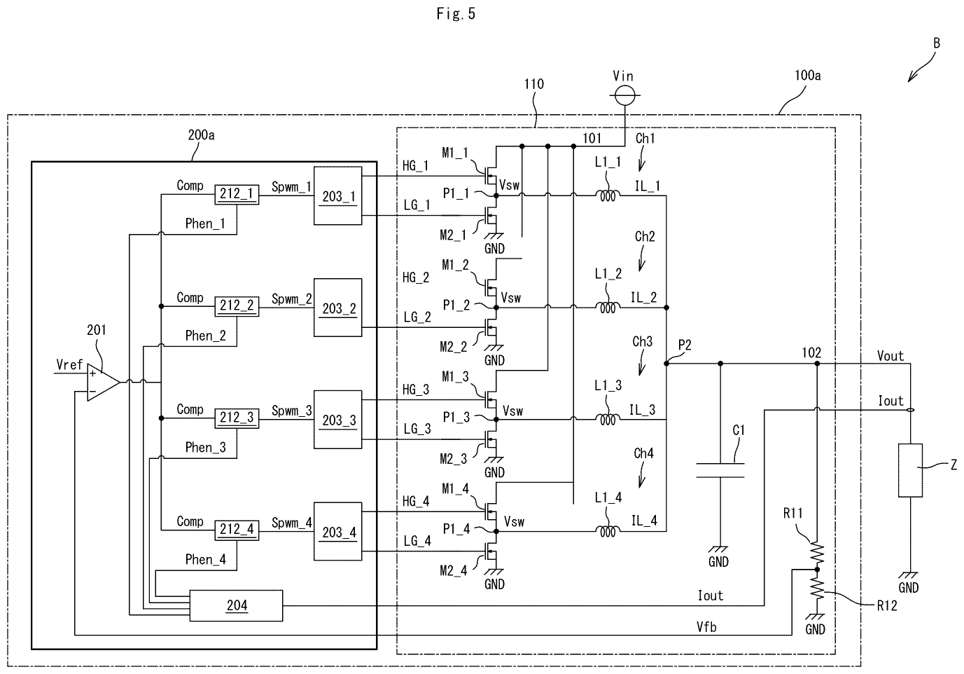

A modified example of the present disclosure will be described below with reference to the relevant drawings. FIG. 5 is an overall configuration diagram of a DC-DC converter 100a according to the modified example of the present disclosure. The DC-DC converter 100a of the modified example differs from the DC-DC converter 100 shown in FIG. 1 in that it incorporates a control circuit 200a that has, instead of the pulse signal generator 202, a pulse signal generator 212. For those parts of the DC-DC converter 100a which are substantially the same as their counterparts in the DC-DC converter 100, the same reference signs will be used and no detailed description will be repeated.

In the DC-DC converter 100, when increasing the number of enabled channels, it is preferable to output the switching voltage Vsw and the inductor currents IL_1 to IL_4 from the switching output stages of all the channels as early as possible. Accordingly, the pulse signal generator 212 of each channel has an edge detection circuit 300 that detects a switch of the enable signal Phen from low level to high level to output a forcing signal Sc.

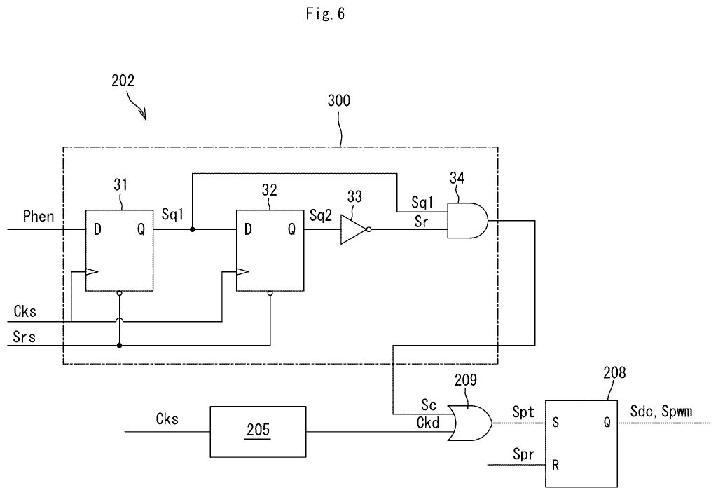

The pulse signal generator 212 will now be described in detail with reference to the relevant drawings. FIG. 6 is a schematic circuit diagram of the pulse signal generator 212 of each channel. In FIG. 6, channel numbers are omitted from illustration.

As shown in FIG. 6, the pulse signal generator 212 has an edge detection circuit 300 and an OR circuit 209. The edge detection circuit 300 includes a first flip-flop 31, a second flip-flop 32, a NOT circuit 33, and an AND circuit 34.

The first and second flip-flops 31 and 32 are each a D flip-flop having a clear terminal. The clock terminals of the first and second flip-flops 31 and 32 are fed with the system clock signal Cks. The reset terminals of the first and second flip-flops 31 and 32 are fed with a system reset signal Srs.

The D terminal of the first flip-flop 31 is fed with the enable signal Phen. The first flip-flop 31 holds the state of the enable signal Phen fed to its D terminal at the rise of the system clock signal Cks and outputs it as a first output signal Sq1 from its output terminal.

The first output signal Sq1 output from the output terminal is fed to the D terminal of the second flip-flop 32. The second flip-flop 32 holds the state of the first output signal Sq1 fed to its D terminal at the rise of the system clock signal Cks and outputs it as a second output signal Sq2 from its output terminal.

The AND circuit 34 is fed with the first output signal Sq1 and an inverted output signal Sr resulting from inverting the second output signal Sq2 in the NOT circuit 33. The forcing signal Sc, which is the output signal of the AND circuit 34, is fed to the OR circuit 209. The OR circuit 209 is fed with, along with the forcing signal Sc, the pulse clock signal Ckd.

A PWM set signal Spt, which is the output signal of the OR circuit 209, is fed to the set terminal of the RS latch circuit 208. The reset terminal of the RS latch circuit 208 is fed with the PWM reset signal Spr, which determines the on-period of the PWM signal Spwm. The output signal of the RS latch circuit 208 is the PWM signal Spwm.

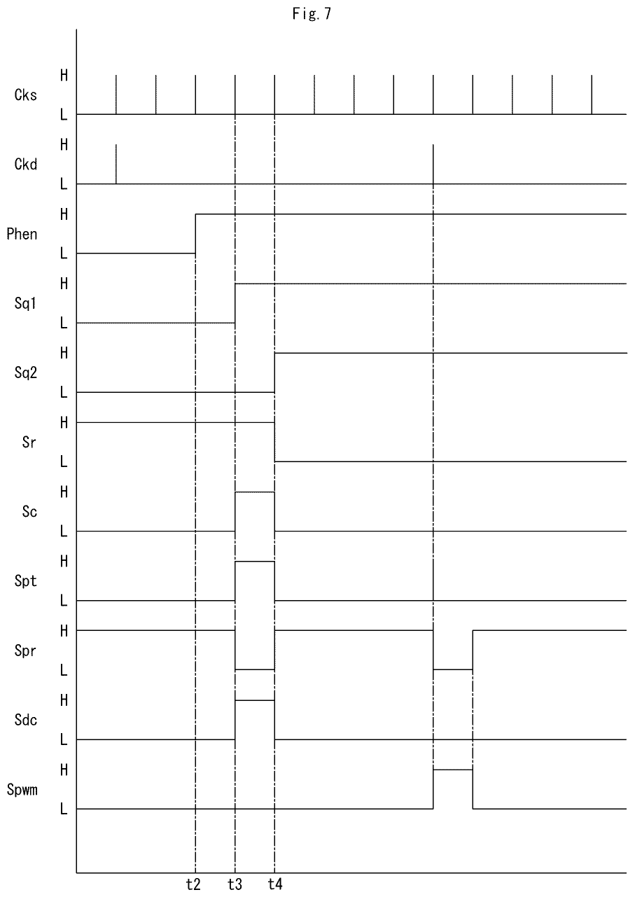

The operation of the pulse signal generator 212 configured as described above will now be described with reference to the relevant drawings. FIG. 7 is a timing chart showing the operation of the pulse signal generator 212. The timing chart in FIG. 7 depicts the change with time of the system clock signal Cks, the pulse clock signal Ckd, the enable signal Phen, the first output signal Sq1, the second output signal Sq2, the inverted output signal Sr, the forcing signal Sc, the PWM set signal Spt, the PWM reset signal Spr, the PWM signal Spwm, and a forcible drive signal Sdc.

As shown in FIG. 7, at time t2, the enable signal Phen switches from low level to high level. The enable signal Phen is fed to the D terminal of the first flip-flop 31, and it switches to high level at the rise timing (time t3) of the system clock signal Cks immediately after time t2.

At the rise timing of the system clock signal Cks, the first output signal Sq1 switches to high level, while the second output signal Sq2 from the second flip-flop 32 switches to high level with a delayed timing. That is, at time t3, the second output signal Sq2 is at low level. Then, immediately after the lapse of the delay time for the first output signal Sq1, at the rise timing (t4) of the system clock signal Cks, the second output signal Sq2 switches to high level.

That is, at time t3, while the first output signal Sq1 switches to high level, the second output signal Sq2 stays at low level and the inverted output signal Srk, resulting from inverting the second output signal Sq2, is at high level. Accordingly, at time t3, the AND circuit 34 is fed with a high-level first output signal Sq1 and a high-level inverted output signal Sr. At time t3, the forcing signal Sc, which is the output signal of the AND circuit 34, is at high level.

At time t4, the second output signal Sq2 switches from low level to high level. Thus, the inverted output signal Sr switches from high level to low level. Moreover, as a result of the inverted output signal Sr switching from high level to low level, also the forcing signal Sc, which is the output of the AND circuit 34, switches to low level.

In this way, from t3 to time t4, the edge detection circuit 300 in the pulse signal generator 212 generates a high-level forcing signal Sc. Incidentally, before t3 and after t4, the forcing signal Sc is at low level.

From time t3 to time t4, since the forcing signal Sc is at high level, the PWM set signal Spt, which is the output signal of the OR circuit 209, is at high level regardless of the state of the pulse clock signal Ckd.

At time t3, the PWM reset signal Spr is at low level. Accordingly, at time t3, when a high-level PWM set signal Spt is fed to its input terminal, the RS latch circuit 208 outputs a forcible drive signal Sdc that is fixed at high level. On receiving the forcible drive signal Sdc, the driver 203 feeds the high-side and low-side driving signals HG and LG to the high-side and low-side switching transistors M1 and M2 respectively. The forcible drive signal Sdc is a signal that drives the driver 203 and can be understood as part of the PWM signal Spwm.

In the pulse signal generator 212, at time t4, the PWM reset signal rises to high level. This resets the output of the RS latch circuit 208. That is, during the previously determined period from time t3 to time t4, the pulse signal generator 212 feeds the forcible drive signal Sdc to the driver 203.

After time t4, the OR circuit 209 is fed with a low-level forcing signal Sc and the pulse clock signal Ckd. Accordingly, the PWM set signal Spt has the same waveform as the pulse clock signal Ckd, behaving as a signal that rises to high level at the same timing. The RS latch circuit 208 outputs the PWM signal Spwm such that it rises at the rise of the PWM set signal Spt and stays at low level during the period in which the PWM reset signal Spr is at high level, in other words, such that it is at high level during the period in which the PWM reset signal Spr is at low level.

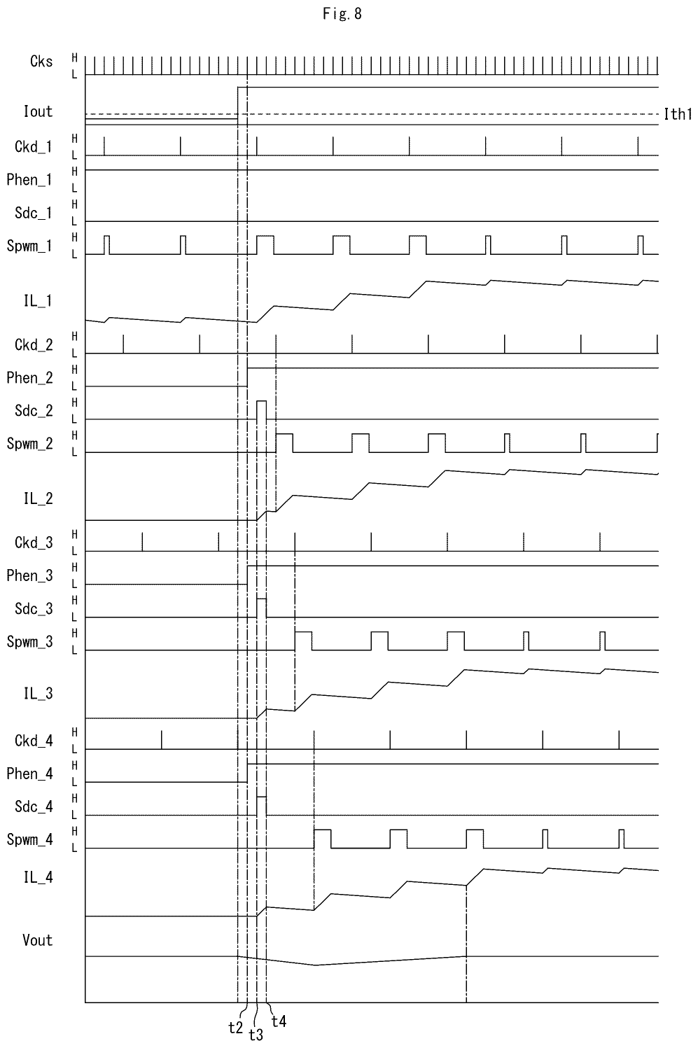

Operating as described above, the pulse signal generator 212 outputs the forcible drive signal Sdc and the PWM signal Spwm. Now the operation of increasing the number of enabled channels in the DC-DC converter 100a will be described with reference to the relevant drawings. FIG. 8 is a timing chart obtained as the number of phases changes in the DC-DC converter 100a according to the modified example.

The timing chart in FIG. 8 depicts the change with time of: the system clock signal Cks; the load current Iout; the enable signals Phen_1 to Phen_4, the pulse clock signals Ckd_1 to Ckd_4, the PWM signals Spwm_1 to Spwm_4, and the inductor currents IL_1 to IL_4 of the individual channels; and the output voltage Vout.

As shown in FIG. 8, the DC-DC converter 100a operates with the number of enabled channels one, that is, in a state where channel Ch1 alone is enabled. At time t2, the multiphase controller 204 judges it necessary to increase the number of enabled channels. At time t2, the multiphase controller 204 switches the enable signals Phen_2 to Phen_4 to high level simultaneously.

From time t3, which is the rise timing of the system clock signal Cks immediately after time t2, to time t4, the pulse signal generators 202_1 to 202_4 of the individual channels forcibly keep the PWM signals Spwm_1 to Spwm_4 at high level. After time t4, the pulse signal generators 202_1 to 202_4 of the individual channels output the PWM signals Spwm_1 to Spwm_4 such that they rise at the rise timings of the pulse clock signals Ckd_1 to Ckd_4 and have specified on-duty ratios.

In the modified example, channel Ch1 is selected as an enabled channel from the beginning. Thus, around t2, the enable signal Phen_1 is at high level and thus the forcing signal Sc_1 stays at low level. Accordingly, the pulse signal generator 202_1 of channel Ch1 continues generating the PWM signal Spwm_1 based on the pulse clock signal Ckd_1 and the PWM reset signal. In a case where, as at start-up, operation is started with the maximum number of channels without channel Ch1 enabled, also the pulse signal generator 202_1, like the pulse signal generators 202_2 to 202_4 of the other channels, generates the PWM signal Spwm_1 such that it stays at high level from time t3 to time t4.

As described above, when operating with all the channels determined to be enabled, the DC-DC converter 100a makes such adjustments that all the switching output stages start to operate simultaneously. This helps reduce the time that elapses after the multiphase controller 204 detects an increase in the load current Iout until all channels Ch1 to Ch4 (except any already enabled channel) operate. It is thus possible to promptly cope with a drop in the output voltage Vout resulting from an increase in the load current Iout in order to suppress the fall of the output voltage Vout.

### Notes

The embodiments described above should be taken to be in very aspect illustrative and not restrictive. The technical scope of the present disclosure is defined not by the above description of embodiments but by the appended claims, and should be understood to encompass any modifications within a scope equivalent in significance to those claims.

According to one aspect of what is disclosed herein, a control circuit (200, 200a) is configured to control a multiphase DC-DC converter (100, 100a) including switching output stages for a plurality of channels (Ch1 to Ch4). It has a multiphase controller (204) that determines the number of enabled channels according to a load current (Iout). When increasing the number of enabled channels, the multiphase controller (204) first switches to the maximum number of channels. (A first configuration.)

In the control circuit (200, 200a) of the first configuration described above, when a predetermined time passes after switching to the maximum number of channels, the multiphase controller (204) can switch to the number of enabled channels corresponding to the load current (Iout). (A second configuration.)

In the control circuit (200, 200a) of the first or second configuration described above, when switching from the maximum number of channels to the number of enabled channels corresponding to the load current, the control circuit can reduce the number of enabled channels one at a time. (A third configuration.)

In the control circuit (200a) of any of the first to third configurations described above, when switching to the maximum number of channels, the multiphase controller (204) simultaneously can enable the switching output stages of at least all channels (Ch1 to Ch4) that are enabled. (A fourth configuration.)

In the control circuit (200, 200a) of any of the first to fourth configurations described above, there can be further provided: a plurality of pulse signal generators (202_1 to 202_4) configured to generate, for the individual channels (Ch1 to Ch4) respectively, PWM (pulse-width modulation) signals (Spwm_1 to Spwm_4) that determine timings at which the switching output stages operate; and a plurality of drivers (203_1 to 203_4) configured to respectively drive the switching output stages of the individual channels (Ch1 to Ch4) based on the PWM signals (Spwm_1 to Spwm_4). (A fifth configuration.)

In the control circuit (200, 200a) of the fifth configuration described above, the pulse signal generators (202_1 to 202_4) can each generate a PWM signal (Spwm_1 to Spwm_4) with a phase shifted relative to PWM signals (Spwm_1 to Spwm_4) generated by the pulse signal generators (202_1 to 202_4) of the other channels (Ch1 to Ch4). (A sixth configuration.)

In the control circuit (200a) of the sixth configuration described above, the multiphase controller (204) can transmit, to the plurality of pulse signal generators (202_1 to 202_4) of the plurality of channels (Ch1 to Ch4) respectively, enable signals (Phen_1 to Phen_4) that enable or disable the channels (Ch1 to Ch4). The pulse signal generators (202_1 to 202_4) can include an edge detector (300) configured to detect switching of the enable signal (Phen_1 to Phen_4) For a previously determined period after the edge detector (300) detects the enable signal (Phen_1 to Phen_4) enabling the channels (Ch1 to Ch4), the pulse signal generators (202_1 to 202_4) can feed the drivers (203_1_203_4) with a forcible drive signal that forcibly operates the switching output stages. (A seventh configuration.)

In the control circuit (200, 200a) of any of the first to seventh configurations described above, the control circuit can be integrated on a single semiconductor substrate. (An eighth configuration.)

According to another aspect of what is disclosed herein, a DC-DC converter includes: the control circuit (200, 200a) of any of the first to eighth configurations described above; and switching output stages for a plurality of channels. (A ninth configuration.)

### Reference Signs List

100, 101a DC-DC converter
101 input line
102 output line
110 output circuit
200, 200a control circuit
201 error amplifier
202, 212 pulse signal generator
203 driver
204 multiphase controller
205 clock signal generator
206 PWM comparator
207 slope circuit
208 RS latch circuit
209 OR circuit
300 edge detection circuit
31 first flip-flop
32 second flip-flop
33 NOT circuit
34 AND circuit
C1 capacitor
L1 inductor
M1 high-side switching transistor
M2 low-side switching transistor
R11 resistor
Z load

1. A control circuit configured to control a multiphase DC-DC converter including switching output stages for a plurality of channels, the control circuit comprising:
a multiphase controller configured to determine a number of enabled channels according to a load current,
wherein
when increasing the number of enabled channels, the multiphase controller first switches to a maximum number of channels.

2. The control circuit according to claim 1, wherein
when a predetermined time passes after switching to the maximum number of channels, the multiphase controller switches to a number of enabled channels corresponding to the load current.

3. The control circuit according to claim 1, wherein
when switching from the maximum number of channels to a number of enabled channels corresponding to the load current, the control circuit reduces the number of enabled channels one at a time.

4. The control circuit according to claim 1, wherein
when switching to the maximum number of channels, the multiphase controller simultaneously enables switching output stages of at least all channels that are enabled.

5. The control circuit according to claim 1, further comprising:
a plurality of pulse signal generators configured to generate, for the individual channels respectively, PWM signals that determine timings at which the switching output stages operate; and
a plurality of drivers configured to respectively drive the switching output stages of the individual channels based on the PWM signals.

6. The control circuit according to claim 5, wherein
the plurality of pulse signal generators each generate a PWM signal with a phase shifted relative to PWM signals generated by pulse signal generators of the other channels.

7. The control circuit according to claim 5, wherein
the multiphase controller transmits, to the plurality of pulse signal generators respectively, enable signals that enable or disable the channels,
the pulse signal generators include an edge detector configured to detect switching of the enable signal, and
for a previously determined period after the edge detector detects the enable signal enabling the channels, the pulse signal generators feed the drivers with a forcible drive signal that forcibly operates the switching output stages.

8. The control circuit according to claim 1, wherein the control circuit is integrated on a single semiconductor substrate.

9. A DC-DC converter comprising:
the switching output stages for the plurality of channels; and
the control circuit according to claim 1.
